(19) United States
(12) Patent Application Publication
(10) Pub. No.: US 2023/0200576 A1
(43) Pub. Date: Jun. 29, 2023

(54) Food Serving Device

(71) Applicant: Ryan LaComb, Stanwood, WA (US)

(72) Inventor: Ryan LaComb, Stanwood, WA (US)

(21) Appl. No.: 17/564,338

(22) Filed: Dec. 29, 2021

(51) Int. Cl. A47G 23/06; A47J 47/08; B65D 43/16; B65D 51/16

(52) U.S. Cl. CPC A47G 23/06; A47J 47/08; B65D 43/163; B65D 51/1605

(57) ABSTRACT

A food serving device for protecting food from insects includes a plate, which has a primary edge and a set of secondary edges. The primary edge is linear. A rim is engaged to and extends from a perimeter of the plate so that the plate and the rim define a tray. A food item is positionable in the tray. A lid is hingedly engaged to the rim above the primary edge. The lid is positioned to selectively close a top of the tray to protect the food item from an insect. The lid is transparent and thus allows viewing of the food item. A plurality of holes is positioned in the lid to vent an interior space defined by the tray and the lid. Each hole has a diameter of less than 1.40 mm so that the holes deter entry of the insect into the interior space.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to serving devices and more particularly pertains to a new serving device for protecting food from insects. The present invention discloses a serving device comprising a tray having a hinged and substantially transparent lid with a plurality of holes positioned therein, wherein the lid is used to protect food items from an insect.

### (2) Description of Related Art Including Information Disclosed Under 37 CFR 1.97 and 1.98

The prior art relates to serving devices. Prior art serving devices may comprise trays having hinged lids, which either are substantially transparent or have ventilation holes positioned therein. What is lacking in the prior art is a serving device comprising a tray having a hinged and substantially transparent lid with a plurality of holes positioned therein, wherein the lid is used to protect food items from an insect.

### BRIEF SUMMARY OF THE INVENTION

An embodiment of the disclosure meets the needs presented above by generally comprising a plate, which has a primary edge and a set of secondary edges. The primary edge is linear. A rim is engaged to and extends from a perimeter of the plate so that the plate and the rim define a tray. The tray is configured for positioning of a food item. A lid is hingedly engaged to the rim above the primary edge. The lid is positioned to selectively close a top of the tray and thus is configured to protect the food item from an insect. The lid is transparent and thus is configured to allow viewing of the food item. A plurality of holes is positioned in the lid and is configured to vent an interior space defined by the tray and the lid. Each hole has a diameter of less than 1.40 mm so that the holes are configured to deter entry of the insect into the interior space.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a food serving device according to an embodiment of the disclosure.

FIG. 2 is a front view of an embodiment of the disclosure.

FIG. 3 is a rear view of an embodiment of the disclosure.

FIG. 4 is a cross-sectional view of an embodiment of the disclosure.

FIG. 5 is a side view of an embodiment of the disclosure.

### DETAILED DESCRIPTION OF THE INVENTION

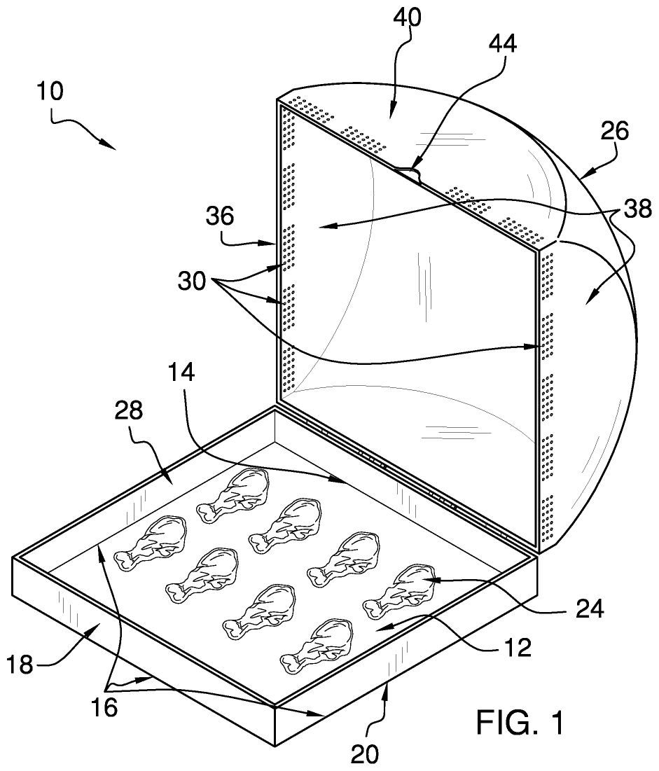

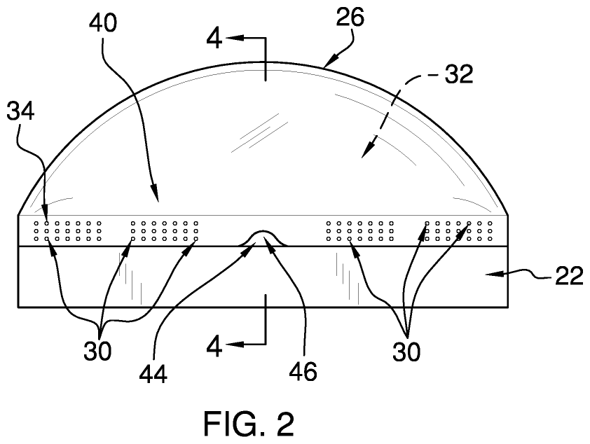

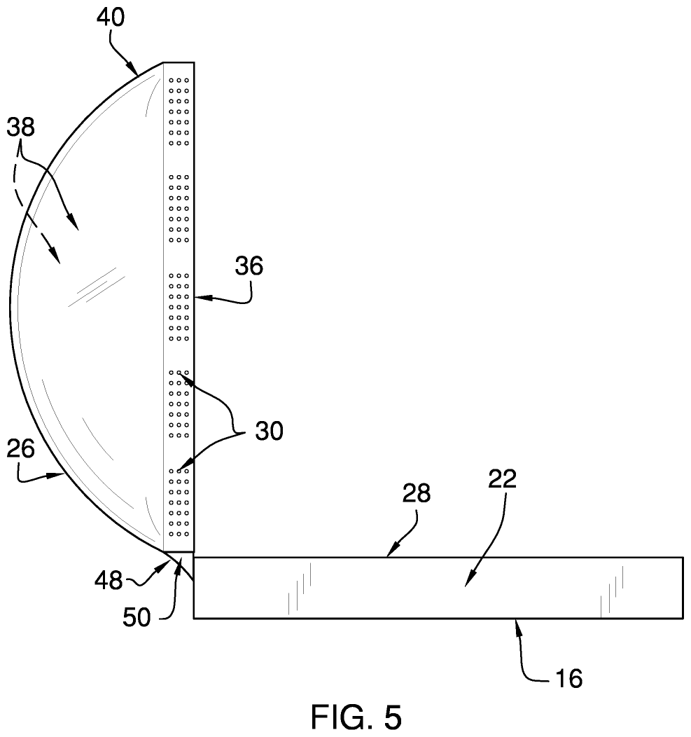

With reference now to the drawings, and in particular to FIGS. 1 through 5 thereof, a new serving device embodying the principles and concepts of an embodiment of the disclosure and generally designated by the reference numeral 10 will be described.

As best illustrated in FIGS. 1 through 5, the food serving device 10 generally comprises a plate 12, which has a primary edge 14 and a set of secondary edges 16. The primary edge 14 is linear. The plate 12 may be rectangular, as shown in FIG. 1, although the present invention also anticipates the plate 12 being alternatively shaped, such as, but not limited to, half-oval (one arcuate secondary edge 16), half-circle (one arcuate secondary edge 16), triangular (two linear secondary edges 16), and the like.

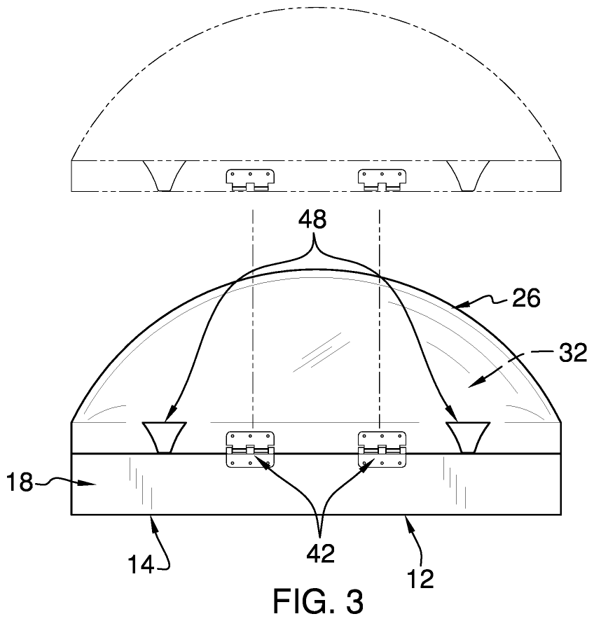

A rim 18 is engaged to and extends from a perimeter 20 of the plate 12 so that the plate 12 and the rim 18 define a tray 22. The tray 22 is configured for positioning of a food item 24, as shown in FIG. 1. The rim 18 may extend substantially perpendicularly from the plate 12, as shown in FIG. 3, although the present invention also anticipates the rim 18 extending transversely from the plate 12. As such, a top 28 of the tray 28 may be circumferentially smaller or larger than the plate 12.

A lid 26 is hingedly engaged to the rim 18 above the primary edge 14. The lid 26 is positioned to selectively close the top 28 of the tray 22 and thus is configured to protect the food item 24 from an insect. The lid 26 is transparent and thus is configured to allow viewing of the food item 24. The lid 26 may be domed so that the lid 26 is configured to accommodate a food item 24 which extends above the top 28 of the tray 22. The present invention also anticipate the lid 26 being alternatively shaped, such as, but not limited to, planar, open-boxed, and the like. The lid 26 comprises plastic, polycarbonate, poly(methylmethacrylate), or the like.

A plurality of holes 30 is positioned in the lid 26 and is configured to vent an interior space 32 defined by the tray 22 and the lid 26. Each hole 30 has a diameter 34 of less than 1.40 mm so that the holes 30 are configured to deter entry of the insect into the interior space 32. The holes 30 are positioned proximate to a lower edge 36 of the lid 26. The holes 30 are positioned in opposed sides 38 and a front 40 of the lid 26.

A set of hinges 42 is engaged to and extends between the rim 18 and the lid 26. The hinges 42 are releasable, for example, by comprising pin-release quick disconnect hinges, pull-release quick disconnect hinges, squeeze-release quick disconnect hinges, or the like. With the hinges 42 being releasable, the tray 22 and the lid 26 are separable, which facilitates storage and cleaning of the food serving device 10. The set of hinges 42 may comprise two hinges 42, as shown in FIG. 3, or other number of hinges 42, such as one hinge 42, three hinges 42, or more than three hinges 42.

A grasp 44 is engaged to the lid 26 and is configured to facilitate hinging of the lid 26. The grasp 44 may comprise a recess 46, or other grasping means, such as, but not limited to, knobs, handles, and the like. The recess 46 extends into the lid 26 and is positioned in the front 40 of the lid 26 proximate to the lower edge 36. The recess 46 is configured for insertion of a digit of a hand of a user, positioning the user for hinging the lid 26.

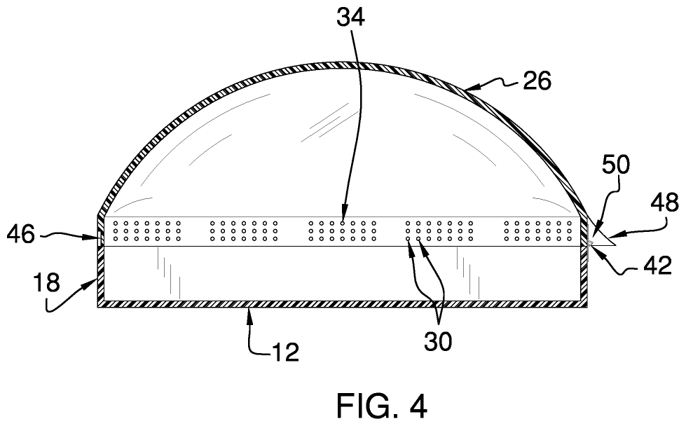

A set of protrusions 48 is engaged to and extends from the lid 26 proximate to the lower edge 36, as shown in FIG. 3. The set of protrusions 48 is positioned to contact the rim 18 when the lid 26 is hinged approximately 90° relative to the tray 22, as shown in FIG. 4. Each protrusion has a substantially triangular cross-sectional profile 50. The set of protrusions 48 may comprise two protrusions 48, which bracket the set of hinges 42, or other number of protrusions 48, such as one protrusion 48, three protrusions 48, or more than three protrusions 48.

In use, the lid 26 is hinged open and the food item 24 is positioned in the tray 22. The lid 26 is then hinged closed to protect the food item 24 from insects. With the lid 26 being substantially transparent, the food item 24 still is viewable.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food serving device comprising:
a plate having a primary edge and a set of secondary edges, the primary edge being linear;
a rim engaged to and extending from a perimeter of the plate, such that the plate and the rim define a tray, wherein the tray is configured for positioning of a food item;
a lid hingedly engaged to the rim above the primary edge, such that the lid is positioned for selectively closing a top of the tray, the lid being transparent, wherein the lid is configured for protecting the food item from an insect and for viewing of the food item; and
a plurality of holes positioned in the lid, wherein the holes are configured for venting an interior space defined by the tray and the lid, each hole having a diameter of less than 1.40 mm, wherein the holes are configured for deterring entry of the insect into the interior space.

2. The food serving device of claim 1, wherein the plate is rectangular.

3. The food serving device of claim 1, wherein the rim extends substantially perpendicularly from the plate.

4. The food serving device of claim 1, wherein the lid is domed, wherein the lid is configured for accommodating a food item extending above the top of the tray.

5. The food serving device of claim 1, wherein the lid comprises plastic, polycarbonate, or poly(methylmethacrylate).

6. The food serving device of claim 1, wherein the holes are positioned proximate to a lower edge of the lid.

7. The food serving device of claim 6, wherein the holes are positioned in opposed sides and a front of the lid.

8. The food serving device of claim 1, further including a set of hinges engaged to and extending between the rim and the lid, the hinges being releasable, such that the tray and the lid are separable.

9. The food serving device of claim 8, wherein the set of hinges comprises two hinges.

10. The food serving device of claim 8, further including a grasp engaged to the lid, wherein the grasp is configured for facilitating hinging of the lid.

11. The food serving device of claim 10, wherein the grasp comprises a recess extending into a front of the lid proximate to a lower edge of the lid, wherein the recess is configured for insertion of a digit of a hand of a user, positioning the user for hinging the lid.

12. The food serving device of claim 8, further including a set of protrusions engaged to and extending from the lid proximate to the lower edge, such that the set of protrusions is positioned for contacting the rim when the lid is hinged approximately 90° relative to the tray.

13. The food serving device of claim 12, wherein each protrusion has a substantially triangular cross-sectional profile.

14. The food serving device of claim 12, wherein the set of protrusions comprises two protrusions bracketing the set of hinges.

15. A food serving system comprising:
a plate having a primary edge and a set of secondary edges, the primary edge being linear;
a rim engaged to and extending from a perimeter of the plate, such that the plate and the rim define a tray;
a food item positioned on the tray;
a lid hingedly engaged to the rim above the primary edge, such that the lid is positioned for selectively closing a top of the tray, such that the lid protects the food item from an insect, the lid being transparent, such that the food item is viewable; and
a plurality of holes positioned in the lid, wherein the holes are configured for venting an interior space defined by the tray and the lid, each hole having a diameter of less than 1.40 mm, wherein the holes are configured for deterring entry of the insect into the interior space.

16. A food serving device comprising:
a plate having a primary edge and a set of secondary edges, the primary edge being linear, the plate being rectangular;
a rim engaged to and extending from a perimeter of the plate, such that the plate and the rim define a tray, wherein the tray is configured for positioning of a food item, the rim extending substantially perpendicularly from the plate;
a lid hingedly engaged to the rim above the primary edge, such that the lid is positioned for selectively closing a top of the tray, the lid being transparent, wherein the lid is configured for protecting the food item from an insect and for viewing of the food item, the lid being domed, wherein the lid is configured for accommodating a food item extending above the top of the tray, the lid comprising plastic, polycarbonate, or poly(methylmethacrylate);
a plurality of holes positioned in the lid, wherein the holes are configured for venting an interior space defined by the tray and the lid, each hole having a diameter of less than 1.40 mm, wherein the holes are configured for deterring entry of the insect into the interior space, the holes being positioned proximate to a lower edge of the lid, the holes being positioned in opposed sides and a front of the lid;
a set of hinges engaged to and extending between the rim and the lid, the hinges being releasable, such that the tray and the lid are separable, the set of hinges comprising two hinges;
a grasp engaged to the lid, wherein the grasp is configured for facilitating hinging of the lid, the grasp comprising a recess extending into the front of the lid proximate to the lower edge, wherein the recess is configured for insertion of a digit of a hand of a user, positioning the user for hinging the lid; and
a set of protrusions engaged to and extending from the lid proximate to the lower edge, such that the set of protrusions is positioned for contacting the rim when the lid is hinged approximately 90° relative to the tray, each protrusion having a substantially triangular cross-sectional profile, the set of protrusions comprising two protrusions bracketing the set of hinges.
